(19) United States
(12) Patent Application Publication
(10) Pub. No.: US 2008/0121303 A1
(43) Pub. Date: May 29, 2008

(54) FLEXIBLE PIG TAIL ASSEMBLY

(76) Inventors: Don C. Leggitt, San Marcos, TX (US); Charles M. Olds, Martindale, TX (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/945,664

(22) Filed: Nov. 27, 2007

Related U.S. Application Data
(60) Provisional application No. 60/867,407, filed on Nov. 28, 2006.

(51) Int. Cl. F16L 11/10

(52) U.S. Cl. 138/109; 138/DIG. 8

(57) ABSTRACT

A flexible tubing assembly comprising a flexible tube having an inner open pathway, with the flexible tube further including a first end and a second end, and a first fitting at the first end of the flexible tube and a second fitting at a second end of the flexible tube. The flexible tube includes a flexible shaping component having shape retention characteristics for allowing the flexible tube to deform to selected shapes multiple times and maintain the selected shapes until the flexible tube is deformed again.

### FIELD OF THE INVENTION

This invention is applicable to a wide range of gas pressure-regulating applications, but is designed for particularly advantageous use for connecting LP-gas regulators to a propane storage tank.

### BACKGROUND OF THE INVENTION

Pig tail assemblies are typically used in residential regulator applications for connecting an LP-gas regulator to a propane storage tank. Heretofore, the pig tail assembly has comprised a copper tube that is brazed to appropriate fittings to make a pressure tight connection. However, the copper tube can be expensive and is prone to cracking and kinking while forming the pig tail assembly into a desired shape. Accordingly, an apparatus is desired having the aforementioned advantages and solving and/or making improvements on the aforementioned disadvantages.

### SUMMARY OF THE PRESENT INVENTION

An aspect of the present invention is to provide a flexible tubing assembly comprising a flexible tube having an inner open pathway, with the flexible tube further including a first end and a second end, and a first fitting at the first end of the flexible tube and a second fitting at a second end of the flexible tube. The flexible tube includes a flexible shaping component having shape retention characteristics for allowing the flexible tube to deform to selected shapes multiple times and maintain the selected shapes until the flexible tube is deformed again.

Another aspect of the present invention is to provide flexible and deformable tubing comprising a flexible tube having an inner open pathway and a flexible shaping component having shape retention characteristics for allowing the flexible tube to deform to selected shapes multiple times and maintain the selected shapes until the flexible tube is deformed again. The flexible shaping component comprises a bendable wire located in the inner open pathway of the flexible tube, with the bendable wire not being directly connected to an inner surface of the flexible tube.

Yet another aspect of the present invention is to provide flexible and deformable tubing comprising a flexible tube having an inner open pathway and a flexible shaping component having shape retention characteristics for allowing the flexible tube to deform to selected shapes multiple times and maintain the selected shapes until the flexible tube is deformed again. The flexible shaping component comprises stiffening material located in the flexible shaping tube between the inner open pathway and an outer surface of the flexible tube.

A further aspect of the present invention is to provide flexible and deformable tubing comprising a flexible tube having an inner open pathway and a flexible shaping component having shape retention characteristics for allowing the flexible tube to deform to selected shapes multiple times and maintain the selected shapes until the flexible tube is deformed again. The flexible shaping component comprises an outer flexible sleeve located over an outer surface of the flexible tube.

These and other aspects, objects, and features of the present invention will be understood and appreciated by those skilled in the art upon studying the following specification, claims, and appended drawings.

### BRIEF DESCRIPTION OF THE DRAWINGS

The following brief description of the figures, and the related figures themselves, exemplifies a particular preferred embodiment of the invention constituting the best mode presently contemplated. As will be understood, other embodiments of the invention as well as changes and variations in the particular structure shown in these figures are no doubt possible, and may very well suggest themselves to those skilled in the art after studying this disclosure and these figures.

FIG. 1 is a front view of a flexible pig tail assembly in accordance with the present invention in a coiled configuration;

FIG. 2 is a front view of the flexible pig tail assembly in accordance with the present invention in an uncoiled configuration;

FIG. 3 is a cross-sectional view of the flexible pig tail assembly in accordance with the present invention taken along the line III-III of FIG. 2;

FIG. 4 is a cross-sectional view of the flexible pig tail assembly in accordance with the present invention taken along the line IV-IV of FIG. 1;

FIG. 5 is a front view of the flexible pig tail assembly in accordance with the present invention in the coiled configuration, with an end of the flexible pig tail assembly shown in cross section;

FIG. 6 is a perspective view of the flexible pig tail assembly in accordance with the present invention in the coiled configuration, with an end of the flexible pig tail assembly shown in cross section;

FIG. 7 is a cross-sectional perspective view of a connection member of the flexible pig tail assembly in accordance with the present invention;

FIG. 8 is a cross-sectional side view of a connection member of the flexible pig tail assembly in accordance with the present invention;

FIG. 9 is a cross-sectional side view of another embodiment of the flexible pig tail assembly in accordance with the present invention; and

FIG. 10 is a cross-sectional side view of yet another embodiment of the flexible pig tail assembly in accordance with the present invention.

### DETAILED DESCRIPTION OF PREFERRED EMBODIMENT

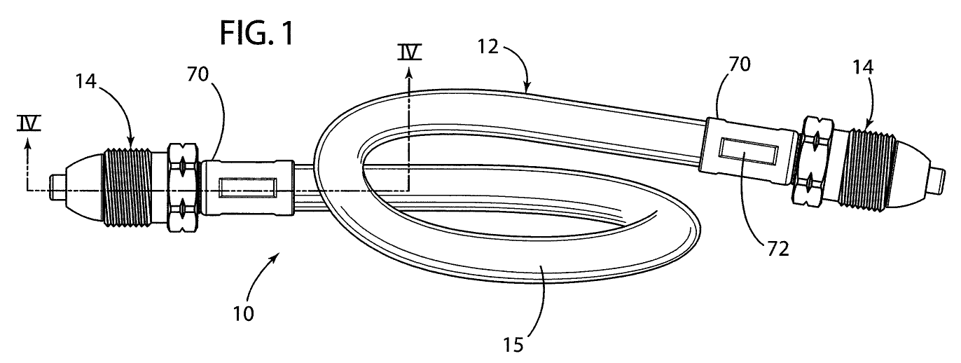

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

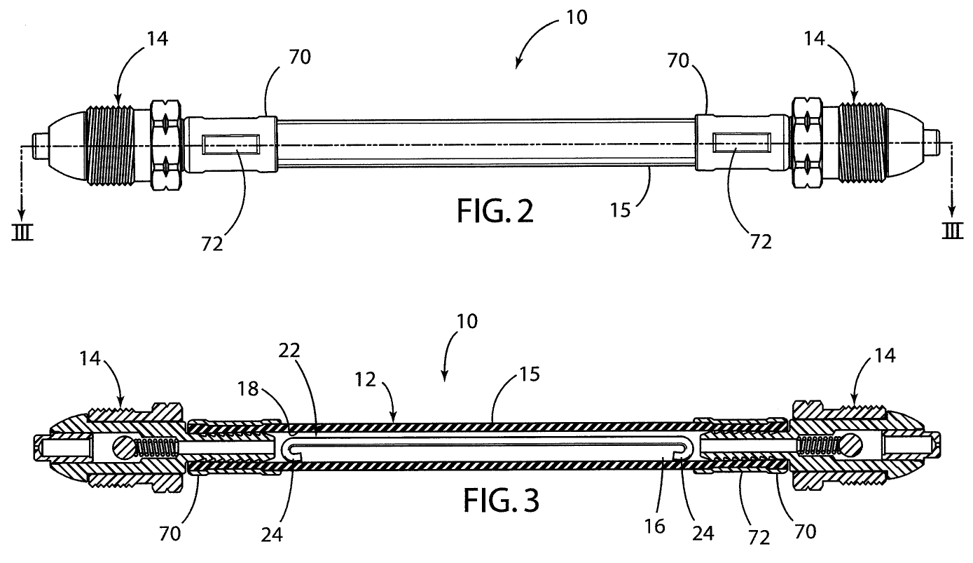

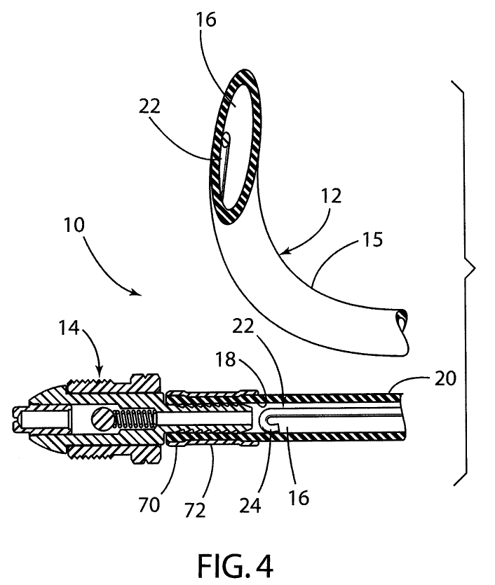

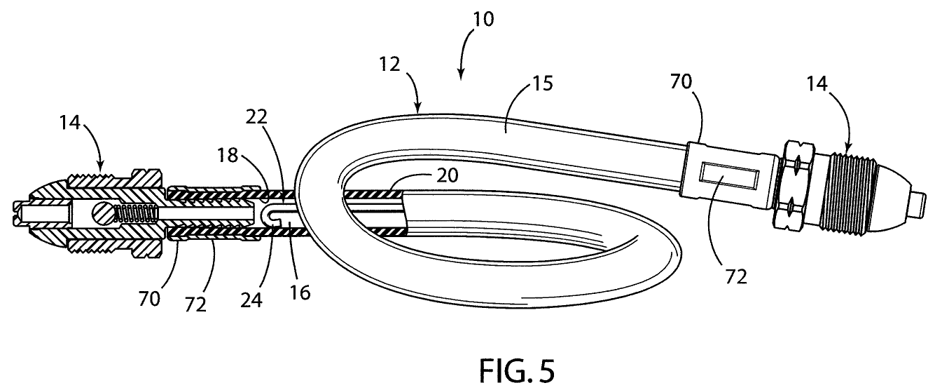

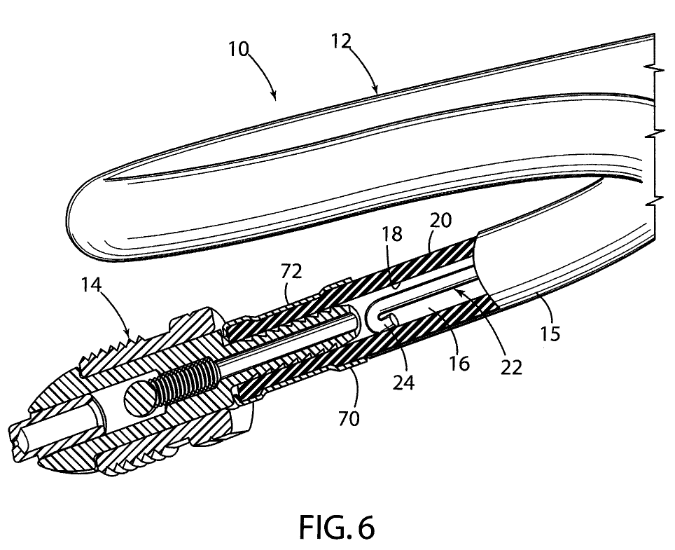

The reference number 10 (FIGS. 1-6) generally designates a flexible pig tail assembly embodying the present invention. In the illustrated example, the flexible pig tail assembly 10 is preferably used for supplying propane gas from a propane storage tank (not shown) to an LP-gas regulator. Such propane storage tanks and LP-gas regulators are well known to those skilled in the art. However, it is contemplated that the flexible pig tail assembly 10 of the present invention could be used to supply any fluid from a source of fluid to another item.

The illustrated flexible pig tail assembly 10 of the present invention includes a hose 12 having a connection member 14 at each end of the hose 12. The hose 12 preferably comprises a tube 15 made of flexible thermoplastic. However, other flexible materials could be used to form the hose 12. Preferably, the tube 15 is made of material that will not generate scaling, which could contaminate equipment downstream of the tube 15. The tube 15 includes an inner open pathway 16 defining an inner surface 18 and an outer surface 20 of the tube 15. The hose 12 includes a wire shaping component 22 located within the inner open pathway 16 of the tube 15. Preferably, the wire shaping component 22 extends along almost all or all of the distance of the inner open pathway 16. However, it is contemplated that the wire shaping component 22 could extend only partially along the distance of the inner open pathway 16. The wire shaping component 22 is flexible such that the hose 12 can be bent to thereby allow a person to form the hose 12 into any shape. For example, the hose 12 can be formed into a coil having at least one loop as illustrated in FIG. 1. Furthermore, the hose 12 can be shaped or coiled and reshaped many times without cracking or kinking the hose 12 and the wire shaping component 22 therein. The wire shaping component 22 is preferably a metal wire. It is further contemplated that the metal wire could have an inert covering that would prevent exposure of the metal wire to the fluid within the tube 15. Moreover, it is contemplated that the wire shaping component 22 could be made of any material that has shape retention characteristics and is corrosion resistant. Furthermore, as illustrated in FIGS. 3, 5 and 6, the wire shaping component 22 preferably includes a bent over portion 24 at each end of the wire shaping component 22.

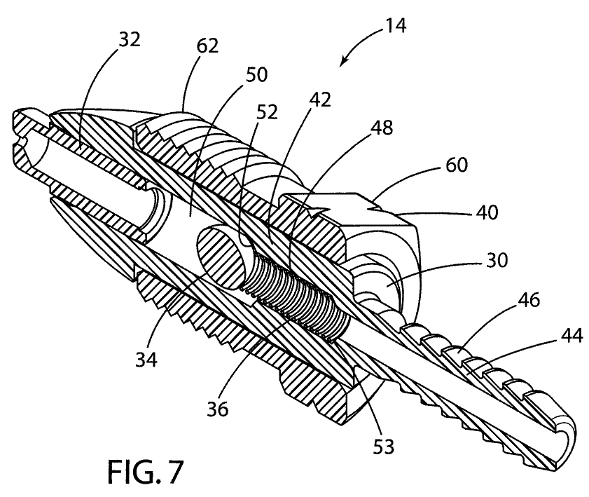

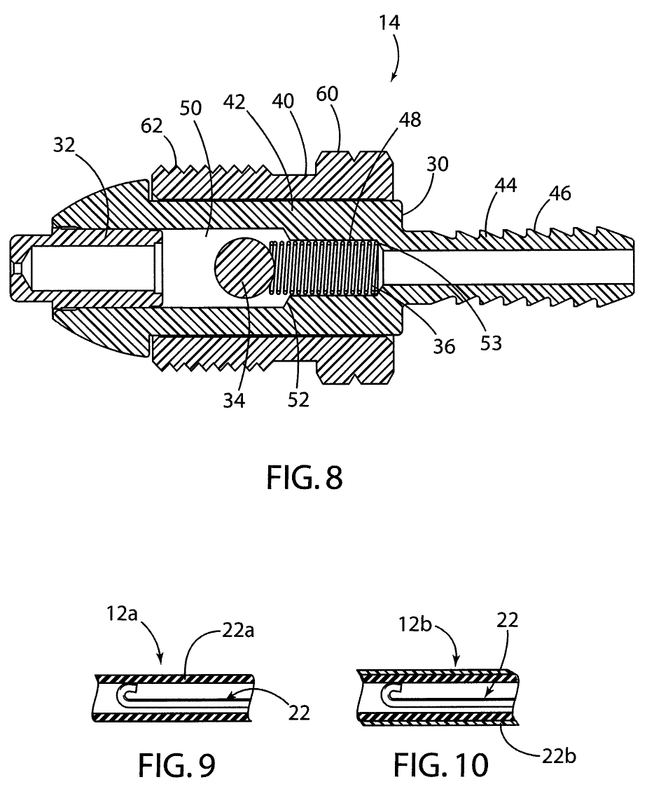

In the illustrated example, one connection member 14 (FIGS. 7 and 8) is connected to each end of the hose 12 for connecting the hose 12 to a source of fuel or any other item. The connection member 14 is preferably a POL coupling. However, any coupling (e.g., a National Pipe Tapered (NPT) thread) could be used to connect the hose 12 to items. The connection member 14 comprises an elongated tubular body 30, a pin guide 32 within the tubular body 30, a valve ball 34, a valve spring 36, and a nut 40. The elongated tubular body 30 includes a large open cylinder portion 42 and a small open cylinder portion 44. The small open cylinder portion 44 has an outside surface having barbs 46. The small opening cylinder portion 44 is configured to be inserted into the inner open pathway 16 at ends of the tube 15 to connect the connection member 14 to the hose 12. The large open cylinder portion 42 includes a small area 48 and a large area 50, with a first step 52 defining a transition between the small area 48 and the large area 50. A second step 53 defines a transition between the small area 48 of the large open cylinder portion 42 and the interior of the small open cylinder portion 42. The valve spring 36 sits on the second step 53 and is located with the small area 48 of the large open cylinder portion 42. The valve ball 34 rests on the valve spring 36 adjacent the first step 52. As is well known to those skilled in the art, the valve spring 36 biases the valve ball 34 away from the first step 52 until pressure downstream raises above a certain level, thereby overcoming the bias of the valve spring 36 and forcing the valve ball 34 against the first step 52 to close the fluid path through the elongated tubular body 30. The pin guide 32 is force fit into the large area 50 of the large open cylinder portion 42 and extends outwardly from the elongated tubular body 30. Furthermore, the nut 40 surrounds the elongated tubular body 30 in an interference fit and includes a nut portion 60 and an externally threaded portion 62. The nut 40 allows the connection member 14 to be attached to an item by a wrench.

The illustrated connection member 14 is preferably threaded into an item until the pin guide 32 opens an automatic shutoff valve in the item, at which time the pin guide 32 sealingly engages a valve seat in the item. The nut 40 allows the connection member to mate with a standardized nut or threaded opening on a hose or pressure regulator leading directly or indirectly to a gas appliance or other item.

In the illustrated example, the pig tail assembly 10 includes a crimped ring 70 to assist in connecting the connection members 14 to the hose 12. The crimped ring 70 surrounds each end of the tube 15. The crimped ring 70 includes a plurality of crimped or indented portions 72 that force the portions of the tube 15 surrounding the barbs 46 of the small open cylinder portion 44 of the elongated tubular body 30 of the connection member to firmly engage the barbs 46 to maintain the connection of the hose 12 with the connection members 14 and to create a pressure tight assembly.

The foregoing detailed description is considered that of a preferred embodiment only, and the particular shape and nature of at least some of the components in this embodiment are at least partially based on manufacturing advantages and considerations as well as on those pertaining to assembly and operation. Modifications of this embodiment may well occur to those skilled in the art and to those who make or use the invention after learning the nature of this preferred embodiment, and the invention lends itself advantageously to such modification and alternative embodiments. For example, instead of or in addition to having the wire shaping component 22 in the tube 15, the hose 12a of the pig tail assembly 10 of the present invention could be made by molding or extruding a wire or other stiffening material 22a into the tube 15 (see FIG. 9). Furthermore, the hose 12b could include an outer sleeve 22b of metal or plastic with shape retention characteristics (see FIG. 10). The outer sleeve 22b could be used instead of the wire shaping component 22 in the tube 15 or the material molded or extruded into the tube 15 or in addition to the wire shaping component 22 in the tube 15. Moreover, it is contemplated that the wire shaping component 22 in the tube 15 could be made of a plastic or foam material with shape memory ability instead of a metal wire.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A flexible tubing assembly comprising:
a flexible tube having an inner open pathway, the flexible tube further including a first end and a second end; and
a first fitting at the first end of the flexible tube and a second fitting at a second end of the flexible tube;
wherein the flexible tube includes a flexible shaping component having shape retention characteristics for allowing the flexible tube to deform to selected shapes multiple times and maintain the selected shapes until the flexible tube is deformed again.

2. The flexible tubing assembly of claim 1, further including:
a plurality of crimp rings for connecting the flexible tube to the first fitting and the second fitting, the crimp rings surrounding the first end and the second end of the flexible tube and including crimps for fixedly connecting the flexible tube to the first fitting and the second fitting.

3. The flexible tubing assembly of claim 2, wherein:
the first fitting and the second fitting each include prongs extending into the inner open pathway of the flexible tube.

4. The flexible tubing assembly of claim 1, wherein:
the flexible tube is comprised of a thermoplastic.

5. The flexible tubing assembly of claim 1, wherein:
the flexible shaping component comprises a bendable wire located in the inner open pathway of the flexible tube, the bendable wire not being directly connected to an inner surface of the flexible tube.

6. The flexible tubing assembly of claim 5, wherein:
the bendable wire includes bent ends formed into a J-shape.

7. The flexible tubing assembly of claim 5, wherein:
the wire is comprised of metal.

8. The flexible tubing assembly of claim 7, wherein:
the wire includes an inert covering.

9. The flexible tubing assembly of claim 5, wherein:
the wire is comprised of plastic.

10. The flexible tubing assembly of claim 5, wherein:
the wire is comprised of foam.

11. The flexible tubing assembly of claim 1, wherein:
the flexible shaping component comprises stiffening material located in the flexible shaping tube between the inner open pathway and an outer surface of the flexible tube.

12. The flexible tubing assembly of claim 1, wherein:
the flexible shaping component comprises an outer flexible sleeve located over an outer surface of the flexible tube.

13. The flexible tubing assembly of claim 1, wherein:
the flexible shaping component comprises stiffening material located in the flexible shaping tube between the inner open pathway and an outer surface of the flexible tube and a bendable wire located in the inner open pathway of the flexible tube, the bendable wire not being directly connected to an inner surface of the flexible tube.

14. The flexible tubing assembly of claim 1, wherein:
the flexible shaping component comprises an outer flexible sleeve located over an outer surface of the flexible tube and a bendable wire located in the inner open pathway of the flexible tube, the bendable wire not being directly connected to an inner surface of the flexible tube.

15. A flexible and deformable tubing comprising:
a flexible tube having an inner open pathway; and
a flexible shaping component having shape retention characteristics for allowing the flexible tube to deform to selected shapes multiple times and maintain the selected shapes until the flexible tube is deformed again, the flexible shaping component comprising a bendable wire located in the inner open pathway of the flexible tube, the bendable wire not being directly connected to an inner surface of the flexible tube.

16. The flexible and deformable tubing of claim 15, wherein:
the bendable wire includes bent ends formed into a J-shape.

17. The flexible and deformable tubing of claim 15, wherein:
the wire is comprised of metal.

18. The flexible and deformable tubing of claim 17, wherein:
the wire includes an inert covering.

19. The flexible and deformable tubing of claim 15, wherein:
the wire is comprised of plastic.

20. The flexible and deformable tubing of claim 15, wherein:
the wire is comprised of foam.

21. A flexible and deformable tubing comprising:
a flexible tube having an inner open pathway; and
a flexible shaping component having shape retention characteristics for allowing the flexible tube to deform to selected shapes multiple times and maintain the selected shapes until the flexible tube is deformed again, the flexible shaping component comprising stiffening material located in the flexible shaping tube between the inner open pathway and an outer surface of the flexible tube.

22. The flexible and deformable tubing of claim 21, wherein:
the flexible shaping component further comprises a bendable wire located in the inner open pathway of the flexible tube, the bendable wire not being directly connected to an inner surface of the flexible tube.

23. A flexible and deformable tubing comprising:
a flexible tube having an inner open pathway; and
a flexible shaping component having shape retention characteristics for allowing the flexible tube to deform to selected shapes multiple times and maintain the selected shapes until the flexible tube is deformed again, the flexible shaping component comprising an outer flexible sleeve located over an outer surface of the flexible tube.

24. The flexible and deformable tubing of claim 23, wherein:
the flexible shaping component further comprises a bendable wire located in the inner open pathway of the flexible tube, the bendable wire not being directly connected to an inner surface of the flexible tube.
